(19) United States
(12) Patent Application Publication
(10) Pub. No.: US 2013/0305703 A1
(43) Pub. Date: Nov. 21, 2013

(54) Integrated Heat and Stirling Engine

(71) Applicant: Taylor Scott Amarel, Grass Valley, CA (US)

(72) Inventor: Taylor Scott Amarel, Grass Valley, CA (US)

(21) Appl. No.: 13/897,321

(22) Filed: May 17, 2013

Related U.S. Application Data
(60) Provisional application No. 61/648,475, filed on May 17, 2012.

(51) Int. Cl. F02G 1/043

(52) U.S. Cl. CPC F02G 1/0435
USPC 60/517

(57) ABSTRACT

A power unit for power generation or transportation. The power unit comprises a barrel cam defining first and second planes and a substantially cylindrical body between the first and second planes. Combustion pistons coupled to the barrel cam and longitudinally disposed relative to the barrel cam so that the combustion pistons longitudinally traverse through the first plane during actuation. First Stirling pistons coupled to the barrel cam and longitudinally disposed relative to the barrel cam so that the first Stirling pistons longitudinally traverse through the first plane during actuation. Second Stirling pistons coupled to the barrel cam and longitudinally disposed relative to the barrel cam so that the second Stirling pistons longitudinally traverse through the second plane during actuation, where at least one of the pistons is coupled to the barrel cam so that the barrel cam rotates during actuation of the pistons.

### CROSS-REFERENCE TO RELATED APPLICATION

This application claims priority under 35 U.S.C. §119(e) to U.S. Provisional Application Ser. No. 61/648,475 titled “Heat Engine Economizer” filed May 17, 2012, the disclosure of which is incorporated herein by reference in its entirety.

### TECHNICAL FIELD

This specification describes technologies relating to integration of engine components to create a power unit and, according to one example implementation, to integrating a Stirling engine into a heat engine and methods of operation.

### BACKGROUND

Efforts have been made to develop technology for making a high efficiency engine. Attempts to create a high efficiency engine include, for example, the addition of direct injection and increased compression ratios. Modern engines for vehicles strive to make efficient use of energy and satisfy requirements regarding emissions.

### SUMMARY

The present disclosure is related to a power unit combining a conventional heat engine with a Stirling engine. While the disclosure makes specific reference to an internal combustion engine, other types of heat producing engines may be used, such as a steam engine, internal combustion engine, external combustion engine, thermoacoustic engine, thermo-magnetic engine, thermal nuclear engine, jet engine, or any other engine or engine like device that either produces heat or uses heat as a means to create motion. The present disclosure utilizes a plurality of novel methods, apparatuses, and means of operation.

The details of one or more embodiments of the subject matter disclosed herein are set forth in the accompanying drawings and the description below. Other features, objects, and advantages of the subject matter described herein will be apparent from the description and drawings, and from the claims.

According to one aspect, a power unit includes heat engine components that generate power by burning fuel, such as a combustion engine, integrated with Stirling engine components that can convert thermal energy to kinetic energy. The power unit may also include a phase changing mechanism, such as a pneumatic valve, that can change the phase between a hot Stirling engine piston and a cold Stirling engine piston, causing the Stirling engine portion to convert kinetic energy into thermal energy, e.g., for storage or for altering a temperature differential between components of the power unit.

The power unit may also include thermal masses that store thermal energy, facilitating the maintenance of a temperature differential between the hot Stirling engine portion and the cold Stirling engine portion. In some implementations, some or all of the thermal masses may be insulated relative to the others. The addition of a single or multiple thermal masses allows for an increased heat capacity and, as a result, more energy can be stored in a temperature differential.

The heat engine components and Stirling engine components are integrated in such a manner that both contribute to the power unit's generation of kinetic energy, e.g., both the heat engine and Stirling engine components cause rotation of a barrel cam connected to an output shaft. The integration of the Stirling engine and internal combustion engine may involve the use of a single engine block or multiple engine blocks or partitions. In some implementations, a Stirling engine phase changing mechanism can be placed within the fluid passages between the hot and cold Stirling engine pistons. For example, the phase changing mechanism may be a pneumatic valve or other mechanism that can alter the Stirling engine passages in such a way that a hot Stirling engine piston chamber can be linked to multiple cold Stirling engine piston chambers in order to achieve an effective change in phase from 90 degrees to −90 degrees.

The internal combustion engine portion is located near the hot portion of the Stirling engine and is thermally connected in a way that allows the heat from combustion to increase the temperature of the hot portion of the Stirling engine. As the combustion engine pistons generate heat, a temperature differential between the hot portion of the Stirling engine and cold portion of the Stirling engine is created. This temperature differential is converted into kinetic energy by the Stirling engine pistons. For example, fluid compression and expansion caused by the temperature differential causes the Stirling engine pistons to facilitate the rotation of a barrel cam that also houses the combustion engine pistons.

The operation of the power unit, and the Stirling engine portion in particular, may be dependent upon the conditions that the power unit is operated under. For example, during a braking condition where it is desired to slow the operating speed of the power unit, the phase changing mechanism may be used to change the phase between a pair of Stirling engine pistons. In some implementations, phase changed is accomplished by altering the Stirling passages between Stirling pistons, such that the phase difference between pairs of Stirling pistons is changed from 90 degrees to −90 degrees. This change in phase may be accomplished by pairing a cold or hot Stirling chamber to another corresponding hot or cold Stirling chamber through the use of a valve-like mechanism that can be controlled and actuated in real time based off, for example, user input, sensors, or other control mechanisms.

In some implementations the phase changing mechanism is a pneumatic valve that can connect one Stirling engine passage to multiple Stirling engine chambers by physically altering the direction of the passage. The phase changing mechanism may be located within the Stirling engine passages and may have a plurality of Stirling passages leading into or up to the Stirling phase changing mechanism. By way of example, a power unit may include 4 Stirling engine pistons. Two hot Stirling engine chambers A and B may each be connected to a corresponding cold Stirling engine chamber, chambers C and D. During an operating mode where braking is not desired, the hot Stirling engine chamber A is connected to cold Stirling chamber C by means of a Stirling engine passage where the operating fluid flows back and forth between chambers A and C. Similarly, Stirling engine chambers B and D would be connected via a similar Stirling engine passage. During the non-braking mode of operation, the phase between the corresponding pistons within chambers A and C would be 90 degrees out of phase respectively, as would the phase between the corresponding pistons within chambers B and D.

During an operating mode where braking is desired, the phase changing mechanism alters the passages by connecting specific hot Stirling engine chambers to specific cold Stirling engine chambers. In the aforementioned example, the phase changing mechanism disconnects Stirling chambers A and C and connects Stirling chambers A and D. Similarly, Stirling chamber B is disconnected from Stirling chamber D and is connected to Stirling chamber C. The Stirling pistons are configured such that, when the phase change mechanism reconnects the Stirling chambers, the phase between the Stirling engine pistons is changed from 90 degrees to −90 degrees. This phase change results, effectively, in changing the Stirling engine into a “heat pump.” When the Stirling engine is operating as a heat pump, the kinetic energy of the power unit is transformed into heat energy. This transformation of kinetic energy to heat energy increases the temperature of the portion of the power unit housing the hot Stirling engine chambers and thus increases the temperature differential between the hot portion of the Stirling engine and the cold portion of the Stirling engine. When the phase between the Stirling engine pistons is switched back to 90 degrees, the Stirling engine is able to utilize the increased temperature differential to increase the power output of the power unit. In implementations where the power unit includes thermal masses, the thermal masses increase the thermal capacity of both the cold portion of the Stirling engine and the hot portion of the Stirling engine, further increasing the amount of thermal energy that can be stored and used by the power unit.

In general, one innovative aspect of the subject matter described in this specification can be embodied in an apparatus, comprising: a barrel cam defining first and second planes and a substantially cylindrical body between the first and second planes and normal to the planes; a plurality of combustion pistons coupled to the barrel cam and longitudinally disposed relative to the barrel cam so that the combustion pistons longitudinally traverse through the first plane during actuation; a plurality of first Stirling pistons coupled to the barrel cam and longitudinally disposed relative to the barrel cam so that the first Stirling pistons longitudinally traverse through the first plane during actuation; a plurality of second Stirling pistons coupled to the barrel cam and longitudinally disposed relative to the barrel cam so that the second Stirling pistons longitudinally traverse through the second plane during actuation; and wherein at least one of the combustion pistons and at least one of the first or second Stirling pistons are coupled to the barrel cam so that the barrel cam rotates during actuation of the at least one of the combustion pistons and the at least one of the first or second Stirling pistons.

These and other embodiments can each optionally include one or more of the following features. The barrel cam may comprise a first profile and a second profile, where the combustion pistons and the first Stirling pistons are coupled to the first profile, and the second Stirling pistons are coupled to the second profile. Each piston may be coupled to a corresponding profile of the barrel cam by a follower.

The apparatus may further comprise: a housing enclosing the barrel cam and pistons, the housing comprising: a first section including, for each of the combustion pistons and first Stirling pistons, a chamber for receiving the piston; and a second section including, for each of the second Stirling pistons, a chamber for receiving the piston; and an output shaft coupled to the barrel cam, the output shaft being longitudinally disposed relative to the barrel cam, wherein a first end of the output shaft protrudes from the first section of the housing, and a second end of the output shaft protrudes from the second section of the housing.

The apparatus may further comprise: a plurality of fluid passages that each connect a chamber for one of the first Stirling pistons to a corresponding chamber for one of the second Stirling pistons; and a phase changing device coupled to two or more of the fluid passages, the phase changing device being operable to switch the chambers to which the two or more fluid passages correspond.

Each corresponding profile may be defined sinusoidally by the barrel cam. Each sinusoidal profile may be defined by the barrel cam such that a first phase for one of the first Stirling pistons is ninety degrees relative to a corresponding one of the second Stirling pistons. Each sinusoidal profile may be defined by the barrel cam such that a first phase for one of the first Stirling pistons is negative ninety degrees relative to a corresponding one of the second Stirling pistons.

A first section of the barrel cam coupled to the combustion pistons and first Stirling pistons may have a radius that is different from a second section of the barrel cam that is coupled to the second Stirling pistons.

In general, another aspect of the subject matter described in this specification can be embodied in an apparatus comprising: an internal heat engine; an integrated Stirling engine; a heating portion for heating an operation fluid; a cooling portion for cooling an operation fluid; and a Stirling phase changing device, wherein the heating portion and the cooling portion having a plurality of heat accumulators arranged therein, and wherein the Stirling phase changing device is operable to change the integrated Stirling engine to a heat pump operation.

These and other embodiments may optionally include one or more of the following features. The power unit may further comprise a plurality of Stirling passages, a plurality of heat accumulators, and a plurality of regenerators which are integrated into an engine block.

The power unit may further comprise a multi-profiled barrel cam defining a plurality of profiles that position a plurality of combustion pistons, a plurality of hot Stirling pistons, and a plurality of cold Stirling pistons.

A plurality of pistons may be transitionally constrained to a multi-profiled barrel cam by a follower. Each piston may comprise one solid piece of material that comprises both a connecting rod and a piston. The profiles defined by the multi-profiled barrel cam may be approximately 90 degrees out of phase. The Stirling phase changing device may comprise a directional valve that modifies a plurality of Stirling working fluid passages.

In general, another aspect of the subject matter described in this specification can be embodied in an apparatus comprising: an integrated Stirling engine and a directional valve device that modifies a Stirling working fluid passages in order to achieve a relative phase change between a heating portion and a cooling portion of the integrated Stirling engine.

In general, another aspect of the subject matter described in this specification can be embodied in an apparatus comprising: an internal heat engine and an integrated Stirling engine constrained by a multi-profiled barrel cam such that the internal heat engine and integrated Stirling engine are physically constrained to each other such that the movement of one causes the movement of the other.

Particular embodiments of the subject matter described in this specification can be implemented so as to realize one or more of the following advantages. A power unit with an integrated Stirling engine can capture and re-use thermal energy produced by a heat engine. The ability to capture and re-use thermal energy facilitates efficient operation of the power unit relative to power units that waste excess thermal energy. In addition, phase changing capabilities of the power unit can assist in braking the power unit while storing thermal energy at the same time.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a perspective view of an example exploded power unit.

FIG. 2 is a side view of an example exploded power unit.

FIG. 3 is a transparent top view of an example exploded power unit.

FIG. 4 is a transparent perspective view of an example exploded power unit.

FIG. 5A is a side view illustrating an example exploded power unit and indicating the cross section of FIG. 5B.

FIG. 5B is a cross section view of an example power unit.

FIG. 6 is a schematic diagram of an example control system for a power unit.

FIG. 7A is a side view illustrating an example exploded power unit and indicating the cross section of FIG. 7B.

FIG. 7B is a cross section view of an example power unit.

FIG. 8 is a graph illustrating a relationship between the output and the phase of an integrated Stirling Engine.

FIG. 9 is an illustration representing the Stirling working fluid passage directional valve of an example power unit.

FIG. 10 is a transparent perspective view of an example exploded power unit including a phase switching valve.

FIG. 11 is a transparent side view of an example exploded power unit including a phase switching valve.

FIG. 12 is an illustration representing the Stirling working fluid passage directional valve of an example power unit.

Like reference symbols in the various drawings indicate like elements.

### DETAILED DESCRIPTION

According to an embodiment of the present disclosure, an integrated Stirling engine's phase may be switched causing an integrated Stirling engine to operate as a heat pump at a time of braking so that the kinetic energy of a machine is transformed into a “temperature differential energy” and is accumulated. By way of example, a power unit may include an internal heat engine, an integrated Stirling engine, a heating portion for heating an operation fluid, a cooling portion for cooling an operation fluid and a Stirling phase changing device, the heating portion and the cooling portion having a plurality of heat accumulators arranged therein. When the engine is required to do negative work, the Stirling phase changing device changes the integrated Stirling engine over to a heat pump operation, so that the temperature of the operation fluid is lowered on the side of the cooling portion to lower the temperature of the heat accumulator of the cooling portion, and that the temperature of the operation fluid is elevated on the side of the heating portion to elevate the temperature of the heat accumulator of the heating portion.

In some implementations, the heat accumulators may be a mass of material with heat capacity. An engine block and a plurality of components may function as or increase the capacity of the heat accumulators. These components may consist of a vehicle frame, body panels, water, cooling material, oil, or any material that can absorb heat. The heating portion of the Stirling engine may be adjacent to a conventional heat engine and the cooling portion of the Stirling engine may be thermally separated from the conventional engine. However, multiple configurations and parts may be used, including additional heating portions, additional cooling portions, and any material or system that can absorb and store heat such as thermoelectric generators, chemical energy storage, or any other energy storage mechanism.

When a brake is being applied, the integrated Stirling engine of an embodiment of the present disclosure for powering the vehicle is changed by the Stirling phase changing device over to a heat pump operation. That is, when a brake is being applied, the integrated Stirling engine that has been producing the power using the heat from the conventional heat engine in the normal traveling is caused to work as a heat pump through a power transmission system of a machine or vehicle. When the brake is applied, the kinetic energy of the vehicle and a drivetrain is consumed and the vehicle's speed decreases. Therefore, driving power is accumulated in a temperature differential when the integrated Stirling engine is operated as the heat pump, whereby the temperature of the operation fluid decreases in the cooling portion and the temperature of the operation fluid increases in the heating portion. Heat accumulators are arranged in the heating portion and in the cooling portion of the integrated Stirling engine. In addition, the heat accumulators may be arranged next to energy generation and storage devices such as an electrical generator, batteries, mechanical flywheel, or similar device. The heat pump operation at the time of braking is accompanied by an increase in the temperature in the heat accumulator of the heating portion and a decrease in the temperature in the heat accumulator of the cooling portion. As a result, the kinetic energy of the vehicle is regenerated as a temperature differential energy being accumulated in the heat accumulators. The difference in temperature between the portions can be small or large and in some situations both portions may be the same temperature. Furthermore, both heat accumulators may be the hottest or coldest accumulator in terms of relative heat energy or temperature.

At the time of accelerating a vehicle, drivetrain, or similar situation the power unit, possibly after having the brake applied but net necessary, the integrated Stirling engine is operated as an engine to drive the vehicle or machine by utilizing the temperature differential energy accumulated in the heat accumulators of the heating portion and the cooling portion. At this moment, the temperature of the heating portion has been elevated to be higher than the temperature in a normal state and the temperature of the cooling portion has been lowered. Therefore, the Stirling engine operates in a state of an increased temperature difference between the high heat source and the low heat source, producing an increased output to power the vehicle, machine, or similar mechanism. Further, the amount of fuel fed to the conventional heat engine can be greatly decreased contributing to improving the fuel economy.

When traveling with little or no load, such as downhill, the integrated Stirling engine may be changed over to the heat pump operation by the Stirling phase changing device. The power required for driving the integrated Stirling engine as the heat pump is larger than the power that the integrated Stirling engine absorbs when it simply operates as the engine brake. Therefore, a strong braking force acts on the vehicle, drivetrain, or machine. For example, the integrated Stirling engine can be operated as a deceleration device which would in turn decrease the burden on the brake when traveling downhill. This facilitates prevention of the fading phenomenon that may be caused by overheated braking components. The energy that may be regenerated while the heat pump is in operation may be transformed into the temperature differential energy, the energy may be accumulated in the heat accumulators, and may be utilized for the subsequent traveling in the same manner as when applying the brake described above. The energy transformed into the temperature differential may also use another energy storage device such as a battery, flywheel, chemical energy storage, or any other storage medium as the sole means of storage or one of many different energy storage mechanisms that can be used in conjunction with one another.

In some implementations, the Stirling engine can include multiple cylinders filled with the operation fluid and connected to each other, multiple pistons reciprocating in the cylinders, and the Stirling phase changing device changing the relative phases of the pistons. The Stirling phase changing device may be any device that can effectively alter the phase offset between pistons, compression cycles, combustion cycles, or any periodic motion within a heat engine. The Stirling phase changing device may change the phase in a discrete number of positions with specific phase offsets. For example, −90 degrees, 0 degrees, 90 degrees, 180 degrees, 270 degrees, or 360 degrees. Additionally, the Stirling phase changing device may change the phase to an infinite number of phase offsets between −360 to 360. Furthermore, the phase changing device may be applied to all pistons, compression cycles, combustion cycles, or any periodic motion within a heat engine, however, the phase changing device may also only be applied to specific pistons, compression cycles, combustion cycles, or any periodic motion within a heat engine and which the functioning and effect of the Stirling phase changing device may be controlled by a computer or otherwise changed in real-time through the use of sensors, user input, or any other control system.

There are various types of Stirling engines, such as the one having a displacer and the one without the displacer, with the Stirling engine of the type of an embodiment of the present disclosure having cylinders filled with the operation fluid and connected with each other and two pistons reciprocating in the cylinders. The placement and type of Stirling phase changing device can be simplified or used in many different configurations as needed. The working mode and output can be adjusted by changing the working fluid passages and thus the relative phases of the two pistons, the Stirling phase changing of the Stirling engine can be changed from the engine operation over to the heat pump operation. To change the integrated Stirling engine over to the heat pump operation, integrated the Stirling engine passages may be switched. For example, the Stirling phase changing device may be a switch that actuates to redirect the passage of working gases in order to achieve multiple phases. The method of changing the Stirling phase by changing the working gas passages of the Stirling engine can be applied to various types of Stirling engines. The Stirling phase changing device may be a switch that is capable of redirecting the working gas.

When the power unit is to be used, it may be advantageous to use a combination of conventional heat engine and Stirling technologies to produce power. During normal driving conditions, the load exerted on the vehicle varies largely depending upon the traveling conditions of the vehicle, such as the vehicle speed, state of road surface and the like. The power unit of an embodiment of the present disclosure provides methods of increasing engine flexibility and reducing the amount of fuel consumed. During a no load or low load situation such as idling the vehicle may not require the power output provided by the conventional heat engine. During a no load or low load situation, the residual heat within the engine block provides adequate power to maintain the momentum of the drivetrain and to recover energy for later use without injecting fuel. When the load increases, the power unit can utilize any stored energy and quickly transfer over to conventional heat engines as the prime mover of the vehicle with limited use of a starting mechanism.

In some implementations, the power unit comprises an internal heat engine and integrated Stirling engine constrained by a multi-profiled barrel cam such that the heat engine and Stirling engine are physically constrained to each other such that the movement of one causes the movement of another. The heating portion of the Stirling engine may be located adjacent to the internal heat engine and the cooling portion of the Stirling engine may be thermally separated from the internal heat engine and heating portion of the Stirling engine.

In some implementations, the power unit comprises of a multi-profiled barrel cam that has at least two profiles. The profiles of the barrel cam allow the pistons of the integrated Stirling engine and internal heat engine to be constrained to the output shaft and each other.

In some implementations, the power unit comprises a multi-profiled barrel cam that has at least two profiles, and these profiles may be out of phase. The out-of-phase profiles provide a method for mounting the pistons of the integrated Stirling engine and internal heat engine. Further, the out-of-phase profiles provide a convenient method for mounting pistons out of phase relative to one another. Further still, the out-of-phase profiles provide a convenient method for mounting the integrated Stirling engine's heat pistons and the integrated Stirling engine's cooling pistons at a predetermined phase off set, such as 90 degrees.

In some implementations, the power unit comprises of an internal heat engine, integrated Stirling engine, and directional valve device that modifies the Stirling passages in order to achieve a relative phase change between the heating portion and cooling portion of the integrated Stirling engine. The direction valve redirects the integrated Stirling engine's working fluid in order to achieve an effective change in phase. The direction valve is used in order to change the phase of the integrated Stirling engine. When the direction valve actuates to one position, it blocks and opens the corresponding integrated Stirling engine working fluid passages to set the phase offset to 90 degrees. In this mode, the integrated Stirling engine works as an engine transforming the temperature difference between the heating portion and cooling portion into work. When the direction valve actuates to another position, it blocks and opens the corresponding integrated Stirling engine working fluid passages to set the phase offset to −90 degrees. In this mode, the integrated Stirling engine functions as a heat pump, and regenerative brake.

In some implementations, the heating portion, cooling portion, Stirling passages, and heat accumulators may be integrated into the engine block.

In some implementations, the integrated Stirling engine may function as an engine producing power to the drivetrain, a regenerative braking device, and a temperature control device.

In some implementations, the integrated Stirling engine may utilize the residual heat from operation of other components and turn it into useful work. In particular, the internal heat engine loses much of its energy to heat loss. The integrated Stirling engines will recovery this heat and turn it into useful work.

In some implementations, the multi-profiles barrel cam comprises of multiple profiles that position the combustion pistons, hot Stirling pistons, and cold Stirling pistons. The arrangement of the pistons on the multi-profiled barrel cam allows for a very compact and efficient engine configuration. Furthermore, the use of multiple profiles allows for separation of pistons. In particular, by mounting the cold Stirling pistons on one profile and the hot Stirling pistons on another profile they may be physically separated increasing the effective thermal insulation between them. Furthermore, the multiple profiles may be different. That is one profile's shape may be optimized for the hot Stirling pistons and the other profiles may be of a shape that optimizes the operation of other components.

In some implementations, the pistons are transitionally contained to the multi-profiled barrel cam. The transitional constraint allows all of the pistons to be mounted parallel to each other and in a compact configuration that increases power density and reduces the number of components required. In some implementations, the radius of one end of the barrel cam is greater than the radius of the opposite end of the barrel cam. In another implementation, the radius of each end of the barrel cam can be the same.

In some implementations, the power unit can utilize the integrated Stirling engine to change the temperature of the power unit in order to achieve maximum operating efficiency. The integrated Stirling engine can be changed from a heat engine to a heat pump in order to cool or heat various components to increase performance and efficiency. It may be desirable to have a mechanism that can pump heat to or from components in order to achieve optimal operating conditions. During a cold start of low operating temperature condition, the Stirling engine may work as a heat pump in order to quickly and efficiently increase the temperature of the components to their optimal operating temperature. Additionally, during a high temperature condition, the Stirling engine may work as an engine in order to cool components to their optimal operating temperature.

During a no load or near no load situation such as idling, injection of fuel may be omitted. During a no fuel situation, the engine can maintain its momentum by using power from the integrated Stirling engine that will run off the residual heat within the engine block. When the car is turned off, the engine may continue running due to the integrated Stirling engines. In a situation where the car is turned off and the engine may still be operating, residual heat energy can be transformed into work by the integrated Stirling engine and then stored. Storage methods may be a battery, compressed air cylinder, insulated heat storage, flywheel storage and a variety of other methods.

The integrated Stirling engines will be capable of maintaining the rotational momentum of the engine for an amount of time; therefore, it is often unnecessary to utilize a starter to get the engine moving.

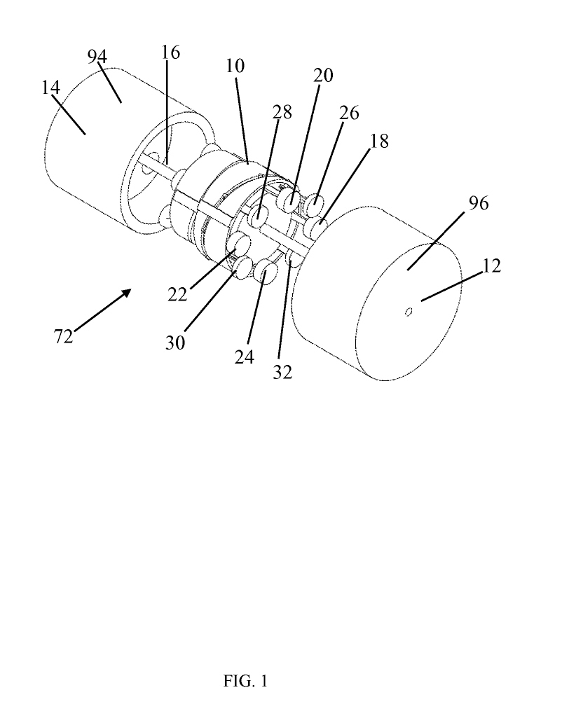

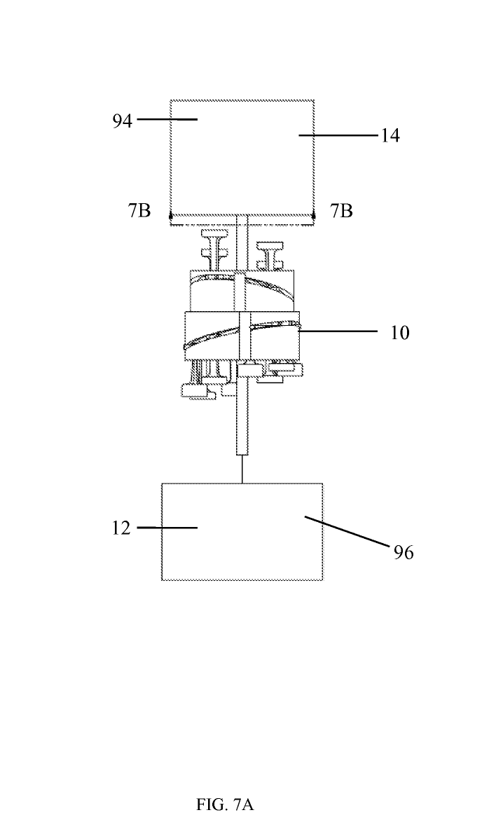

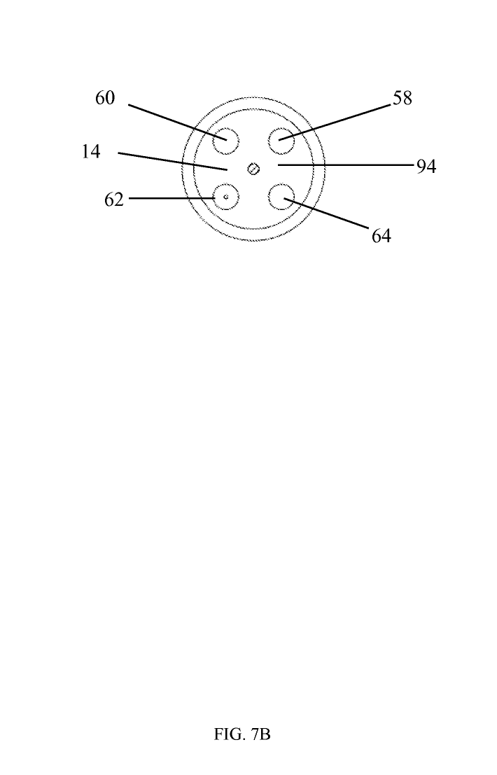

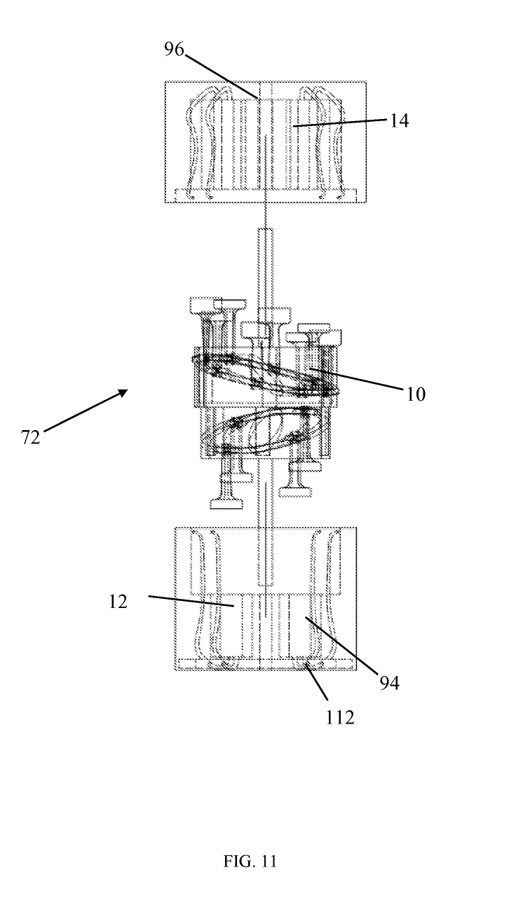

The example power unit 72 of an embodiment of the present disclosure will now be described with reference to the drawings. The power unit of the embodiment of FIGS. 1-4, 5A, 5B, 7A, 7B, 10 and 11 is of the type of an engine equipped with cylinder chamber/piston mechanisms arranged in parallel, the Stirling pistons 26, 28, 30, 32 serving as pistons on the expansion side and the Stirling pistons 34, 36, 38, 40 serving as pistons of the compression side of the integrated Stirling engine. The cylinder spaces in the upper part of the pistons 26, 28, 30, 32 are heating spaces, and the integrated Stirling cylinder spaces in the upper part of the pistons 34, 36, 38, 40 are cooling spaces, the heating spaces 50, 52, 54, 56 and the cooling spaces 58, 60, 62, 64 being connected via passages 66, 74, and directional control valve 98. Spaces 50, 52, 54, 56, 58, 60, 62, 64 and constitute operation chambers of the Stirling engine containing an operation fluid comprising a gas having a small specific heat, such as hydrogen, helium, etc. A regenerator may be installed in the passage to improve the cycling efficiency by accumulating the heat of the operation fluid that moves between the spaces 50, 52, 54, 56 and 58, 60, 62, 64. The power unit's engine blocks 12, 14 and other components may function as a regenerator.

A heating portion may be arranged adjacent to the conventional heat engine to heat the operation fluid in the heating spaces 50, 52, 54, 56 and a cooling portion is arranged on the cooling spaces 58, 60, 62, 64 to cool the operation fluid in the cooling space. Fuel is fed from a fuel-feeding device, not shown, into the conventional engine and is burned therein. Thermal energy from combustion is used as the primary source of heat for the heating portion 96 of the Stirling engine. The cooling portion 94 may be of the form of a heat sink like device for radiating the heat of the operation fluid into the atmosphere or a refrigeration system. The pistons 26, 28, 30, 32, 34, 36, 38, 40 are transitionally coupled to a multi-profiled barrel cam 10, and the internal heat engine pistons 18, 20, 22, 24 are similarly coupled to a multi-profiled barrel cam 10. The multi-profiled barrel cam 10 is connected to a power transmission. When the vehicle is normally traveling, the vehicle is driven by a combination of the integrated Stirling engine and internal heat engine.

In the power unit 72 Stirling engine of FIGS. 1-4, 5A, 5B, 7A,7B, 10 and 11 of the embodiment of the present disclosure, heat accumulators 96 are provided in the heating portion and, a heat accumulator 94 is provided in the cooling portion. These heat accumulators 94, 96 are masses of a material having a heat capacity, such as of a metal or ceramics. The working fluid passages 74, 76 between the heating spaces 50, 52, 54, 56, are coupled to the cooling spaces 58, 60, 62, 64 and are coupled through a directional valve mechanism 98 that is the working mode changing device, and the phase difference is variable between the pistons 26, 28, 30, 32 and the pistons 34, 36, 38, 40. The phase difference may be, for example, −90 or 90 degrees.

As discussed above, in some implementations a barrel cam 10 defines a first plane 13 and a second plane 15 and a substantially cylindrical body between the first plane 13 and second plane 15 and normal to the planes. Combustion pistons (18, 20, 22, and 24) are connected to the barrel cam 10 and longitudinally disposed relative to the barrel cam 10 so that the combustion pistons longitudinally traverse through the first plane 13 during actuation. A set of first Stirling pistons (26, 28, 30, and 32) are connected to the barrel cam 10 and longitudinally disposed relative to the barrel cam 10 so that the first Stirling pistons longitudinally traverse through the first plane 13 during actuation. A second set of Stirling pistons (34, 36, 38, and 40) are connected to the barrel cam 10 and longitudinally disposed relative to the barrel cam 10 so that the second Stirling pistons longitudinally traverse through the second plane 15 during actuation. At least one of the combustion pistons and at least one of the first or second Stirling pistons are connected to the barrel cam 10 so that the barrel cam 10 rotates during actuation of the corresponding pistons.

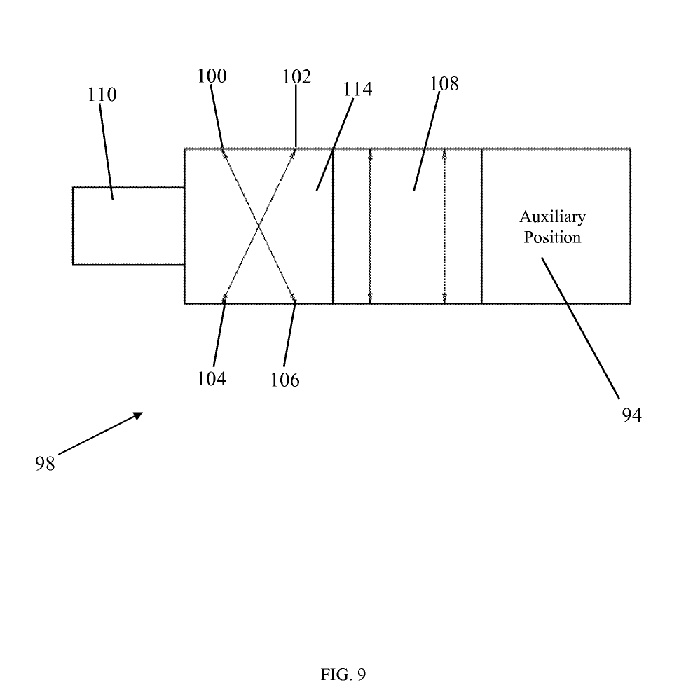

Referring to FIGS. 9-12, the example phase difference changing mechanism 98 is a valve mechanism. Passages are formed in the engine blocks 12, 14 and the valve mechanism 98 is mounted in the working fluid passages 74, 76 to regulate and direct the flow of the working fluid. That is, upon adjusting the position of the directional valve 98 by using an actuator or the like, the phase difference can be adjusted between the pistons 26, 28, 30, 32 and the pistons 34, 36, 38, 40 that are reciprocally moving at the same time.

When the vehicle is normally traveling, the integrated Stirling engine operates assisting the internal heat engine for driving the vehicle. The phase difference between the pistons 26, 28, 30, 32 and the pistons 34, 36, 38, 40 is set by the phase difference-changing mechanism 98 to be about 90 degrees which is well suited for the operation of the engine. That is, in a state where the engine is in operation, the phase difference is so set that the volume of the cooling spaces 58, 60, 62, 64 varies maintaining a phase delayed by 90 degrees behind the change in the volume of the heating spaces 50, 52, 54, 56. The operation fluid in the operation chambers constituted by the heating spaces 50, 52, 54, 56 and the cooling spaces 58, 60, 62, 64 undergoes the Stirling cycle repeating the change of state while moving between the two spaces depending upon changes in the volumes of the operation chambers. Therefore, the heat from the heating portion 96 is transformed into useful work, and the drive wheels of the vehicle are rotationally driven by the double profiled barrel cam 10.

At the time of breaking the vehicle, the phase difference-changing mechanism 98 changes the phase between the pistons 26, 28, 30, 32 and the pistons 34, 36, 38, 40 so that the volume of the cooling spaces 58, 60, 62, 64 varies maintaining a phase 90 degrees ahead of the change in the volume of the heating spaces 50, 52, 54, 56. Due to this change, the state of the operation fluid changes, and the integrated Stirling engine undergoes the so-called inverse Stirling cycle, and the integrated Stirling engine operates as the heat pump. When the brake is applied, the kinetic energy of the vehicle is consumed. Therefore, a large amount of energy is fed to the Stirling engine from the drive wheels, whereby the temperature decreases in the cooling spaces 58, 60, 62, 64 and, at the same time, the temperature increases in the heating spaces 50, 52, 54, 56. As a result, the accumulators 96 acquire a high temperature in the heating portion; heat energy is accumulated therein. The temperature of the heat accumulator 94 in the cooling portion decreases and “cold energy” is accumulated therein.

The temperature differential energy accumulated in the heat accumulators 94, 96 at the time of applying the brake of the vehicle is utilized at the time of accelerating the vehicle again. At the time of acceleration, the phase difference-changing mechanism 98 is actuated so that the phases of the pistons 50, 52, 54, 56 and the pistons 58, 60, 62, 64 assume a state of executing the engine cycles. At this moment, the integrated Stirling engine operates due to the temperature differential energy accumulated in the heat accumulators, in the heating portion and in the cooling portion. The Stirling engine produces a large output that can power accessories or accelerate the vehicle. Further, use of the accumulated temperature differential energy makes it possible to greatly decrease the amount of fuel that is fed to the internal heat engine.

When the vehicle is traveling downhill, the phase difference-changing mechanism 98 changes the Stirling engine over to the heat pump operation. The power for driving the Stirling engine as the heat pump is larger than the power which the Stirling engine absorbs when it is working as an engine brake. Therefore, a strong braking force acts on the vehicle making it possible to decrease the burden on the foot brake. The energy regenerated as the temperature differential energy while the vehicle is traveling downhill is utilized for the later powering of the vehicle like the case of when the brake is applied.

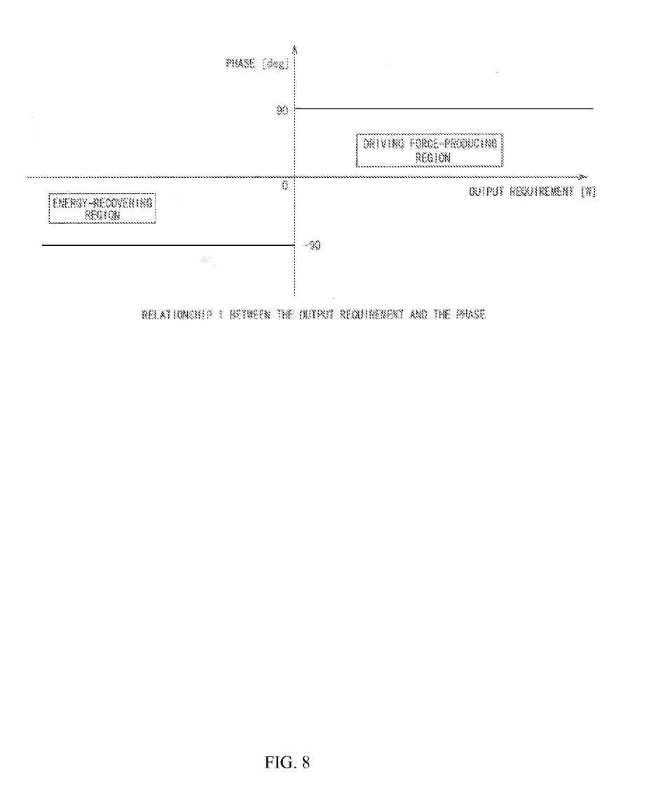

FIG. 8 is a graph illustrating a relationship between the output and the phase of an integrated Stirling Engine. A vehicle control unit for controlling the phase difference-changing mechanism 98 receives a position signal from the accelerator pedal of the vehicle, brake pedal, engine temperature sensors, and other powertrain sensors or user input. When the accelerator pedal is depressed, the vehicle control unit adjusts the position of a directional valve 98 so that the integrated Stirling engine operates as an engine, and so that the phases of the two pistons are best suited for the engine operation. It is also possible to control the phase difference changing mechanism based on other sensors and driver input in order to achieve a desired effect. Further, the depression of the brake pedal causes the vehicle control unit to changes the position of the phase difference-changing device 98 so that the integrated Stirling engine works as the heat pump.

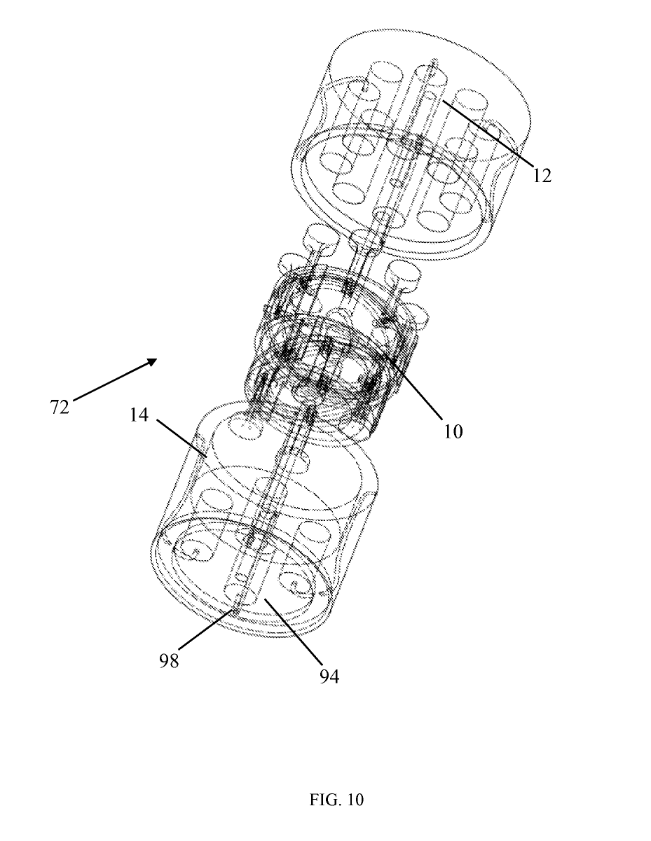

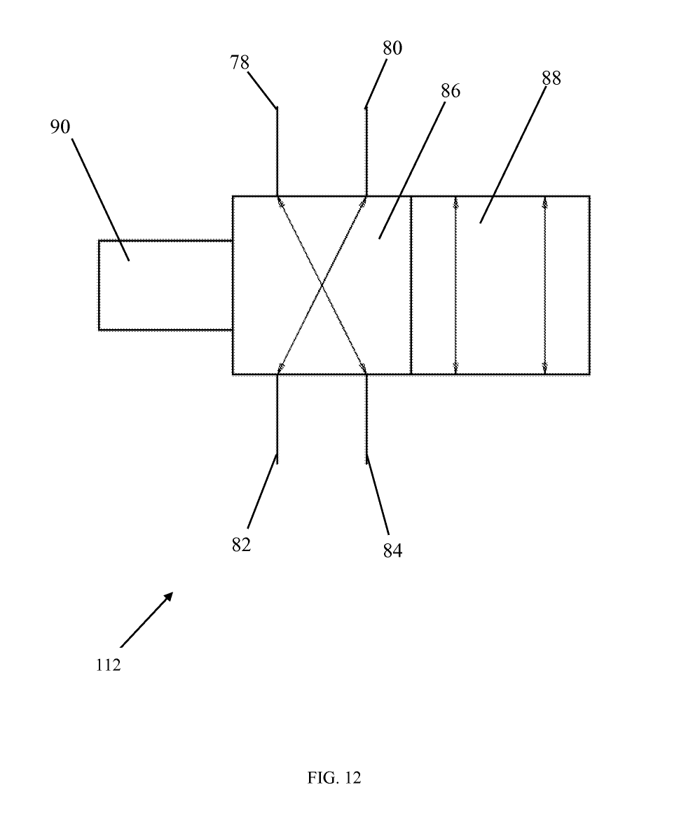

Referring now to FIGS. 9-12 in more detail, in FIG. 10 is a transparent perspective view of an example exploded power unit including a phase switching valve. In further detail, the Stirling working fluid valve 96 of FIG. 12 illustrates a potential embodiment of the Stirling working fluid valve 98. The Stirling working fluid valve 98 is mounted in the power unit 76 such that a hot Stirling passage with a phase offset of 0 degrees couples to the Stirling working fluid valve 98 at joint 100. A hot Stirling fluid passage with a phase offset of 180 degrees couples to the Stirling working fluid valve 98 at joint 102. A cold Stirling fluid passage with a phase offset of 90 degrees is coupled to the Stirling working fluid valve 98 at joint 104. A cold Stirling fluid passage with a phase offset of 270 degrees is coupled to the Stirling working fluid valve 98 at joint 84. The positions 114, 108, 94 of the Stirling working fluid valve 98 allow the Stirling working fluid valve 98 to change the Stirling offset to 90 degrees at position 108 and −90 degrees at position 114. The Stirling working fluid valve 98 has an actuating mechanism represented by 110 that may be electronic, hydraulic, pneumatic, etc, and is controlled by the power train control unit. FIG. 9 illustrates an alternate embodiment of the Stirling working fluid valve of FIG. 12. FIG. 12 has an additional auxiliary position 94 that may be used to store compressed air, alter the fluid pressure, or redirect air for other components.

Referring now to an embodiment of the disclosure in more detail, in FIG. 1 there is shown an integrated engine heat recovery system 72 comprised of a multi-profiled barrel cam 10, an upper portion of an engine block 12, a lower portion of an engine block 14, a shaft 16, combustion pistons 18, 20, 22, 24, and hot Stirling engine pistons 26, 28, 30, 32.

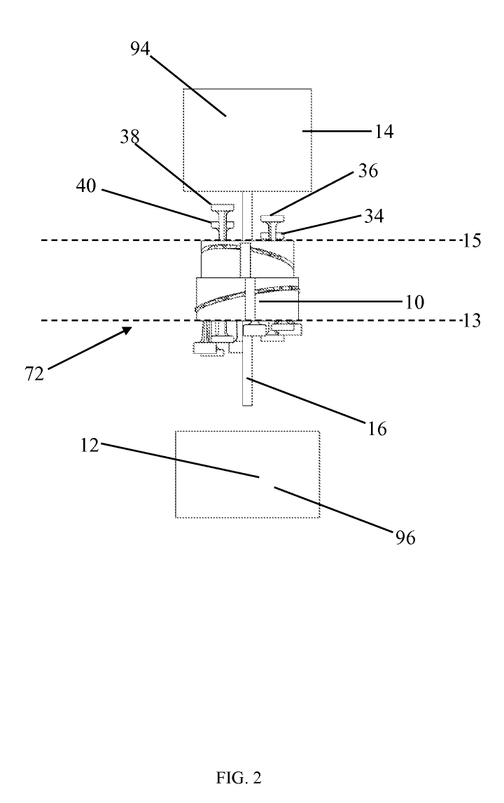

Referring now to an embodiment of the present disclosure in more detail, in FIG. 2 there is shown an integrated engine heat recovery system 72 comprised of a multi-profiled barrel cam 10, an upper portion of an engine block 12, a lower portion of an engine block 14, a shaft 16 and cold Stirling engine pistons 34, 36, 38, 40.

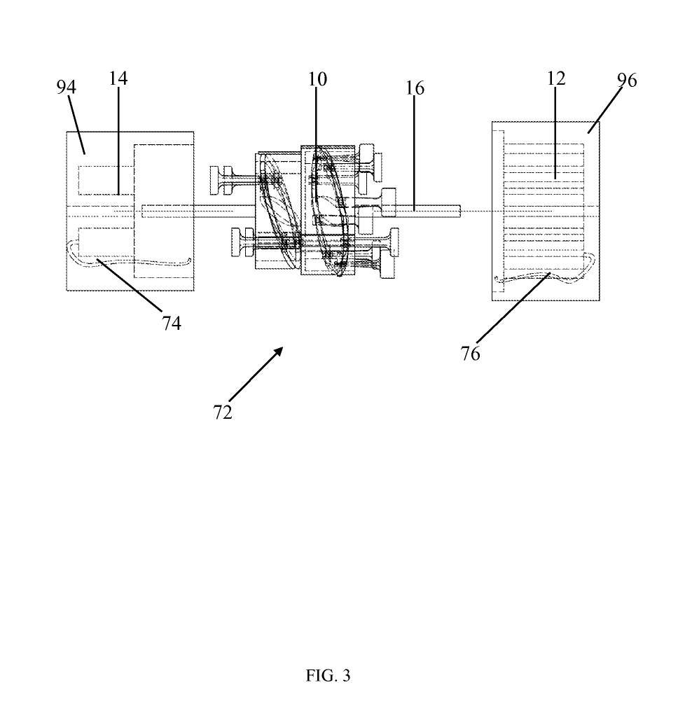

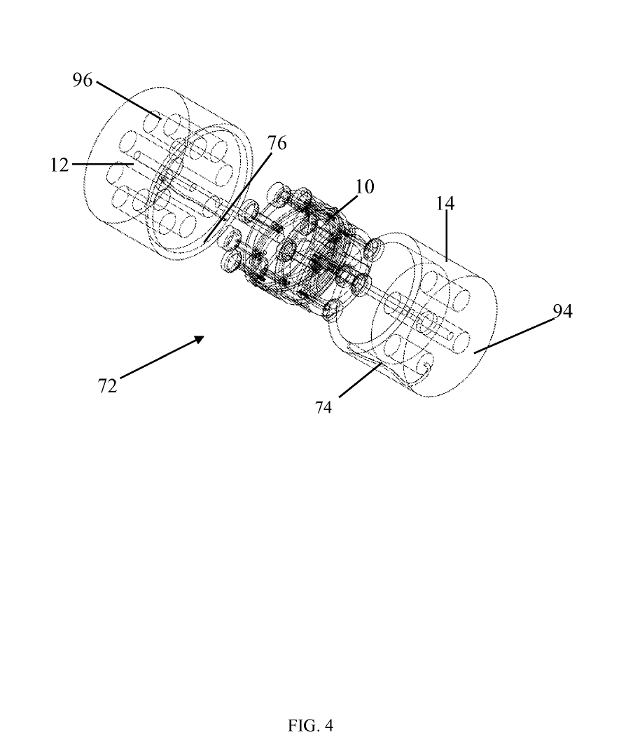

Referring now to an embodiment of the present disclosure in more detail, in FIGS. 3 and 4 there is shown an integrated engine heat recovery system 72 comprised of a multi-profiled barrel cam 10, an upper portion of an engine block 12, a lower portion of an engine block 14, a shaft 16, two Stirling working gas passages 74, 76.

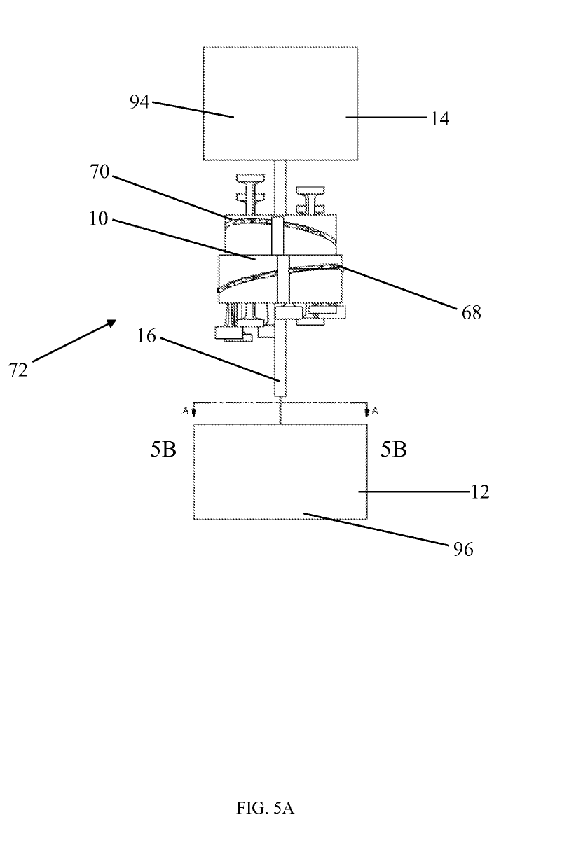

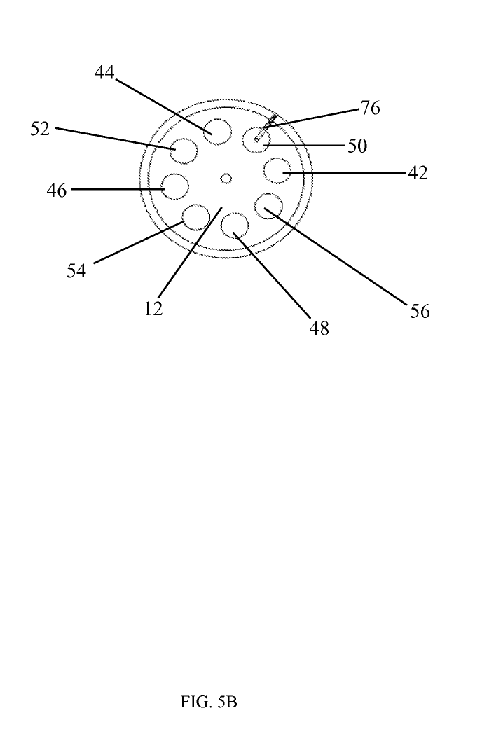

Referring now to an embodiment of the present disclosure in more detail, in FIG. 5 there is shown an integrated engine heat recovery system 72 comprised of a multi-profiled barrel cam 10, an upper portion of an engine block 12, a lower portion of an engine block 14, a shaft 16, combustion cylinders 42, 44, 46, 48, hot Stirling cylinders 50, 52, 54, 56, Stirling working gas passages 74, 76 top follower profile 68, and bottom follower profile 70. In an example implementation, the followers connected to the pistons are roller bearings. The followers, also commonly referred to as cam followers, track followers, studs, yokes, or roller followers, may be a compact bearing with a rigid shaft and built in needle bearings. However, the present disclosure is not constrained to only roller bearings; the followers may be in any physical form that allows the followers to be constrained to the profile of the barrel cam.

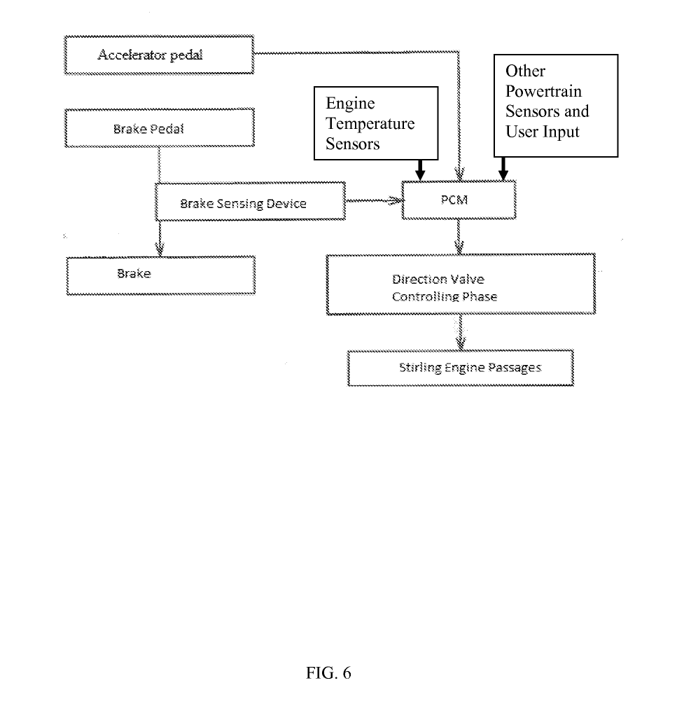

Referring now to an embodiment of the present disclosure in more detail, in FIG. 6 there is shown an integrated engine heat recovery system 72 comprised of a multi-profiled barrel cam 10, an upper portion of an engine block 12, a lower portion of an engine block 14, a shaft 16, and cold Stirling cylinders 58, 60, 62, 64.

In more detail, referring to an embodiment of the present disclosure of FIGS. 1-6, the multi-profiled barrel cam 10 has two sinusoidal like profiles (e.g., grooves in the barrel cam for receiving followers connected to the pistons), barrel cam profile top 68, and barrel cam profile bottom 70. Barrel cam profile top 68 and barrel cam profile bottom 70 are approximately 90 degrees out of phase. The multi-profiled barrel cam 10, barrel cam profile top 68, and barrel cam profile bottom 70 provide the hot Stirling pistons 26, 28, 30, 32, the combustion pistons 18, 20, 22, 24, and the cold Stirling pistons 34, 36, 38, 40 with a contact surface that secures the hot Stirling pistons 26, 28, 30, 32, the combustion pistons 18, 20, 22, 24, and the cold Stirling engine pistons 34, 36, 38, 40 within the upper portion of the engine block 12 and the lower portion of the engine block 14. The hot Stirling pistons 26, 28, 30, 32, the combustion pistons 18, 20, 22, 24, and the cold Stirling pistons 34, 36, 38, 40 are constrained transitionally to the multi-profiled barrel 10. The arrangement of the hot Stirling engine pistons 26, 28, 30, 32, the combustion pistons 18, 20, 22, 24, and the cold Stirling engine pistons 34, 36, 38, 40, allow the reciprocating movement of the pistons to rotate the multi-profiled barrel cam 10 and the shaft 16. As the combustion pistons 18, 20, 22, 24 reciprocate along the barrel cam profile top 68, the multi-profiled cam 10 and shaft 16 rotate. The hot Stirling pistons 26, 28, 30, 32, and the cold Stirling pistons 34, 36, 38, 40 behave in a similar manner to the combustion pistons. Rotating the shaft 16 will also cause the combustion pistons 18, 20, 22, 24, the hot Stirling pistons 26, 28, 30, 32, and the cold Stirling pistons 34, 36, 38, 40 to reciprocate. The linear force of the combustion pistons 18, 20, 22, 24 is supplied by the expansion of gas within the combustion cylinders 42, 44, 46, 48. The hot Stirling pistons 26, 28, 30, 32 absorb much of the thermal energy within the engine. As the working gas within the hot Stirling cylinders 50, 52, 54, 56 increases in temperature above the temperature in the cold Stirling pistons 34, 36, 38, 40, the hot Stirling pistons 26, 28, 30, 32, and cold Stirling pistons 34, 36, 38, 40 begin to reciprocate in the Stirling cycle. The Stirling engine operates by cyclic compression and expansion of the working gas, at different temperature levels such that there is a net conversion of heat energy to mechanical work. The cyclic transfer of the working gas from the hot Stirling cylinders to the cold Stirling cylinders is done via two Stirling working gas passages 74, 76. The engine block 14, 12, and any other components such as water or oil act as a regenerator. The cold Stirling cylinders 58, 60, 62, 64 are adequately separated from the hot Stirling cylinders or cooled such that the cold Stirling cylinders 58, 60, 62, 64 operating temperature is always below the hot Stirling cylinders temperature.

In further detail, referring to an embodiment of the present disclosure of FIGS. 1-12, all mentioned components of the multi-profiled barrel cam 10, an upper portion of an engine block 12, a lower portion of an engine block 14, a shaft 16, hot Stirling engine pistons 26, 28, 30, 32, combustion pistons 18, 20, 22, 24, cold Stirling engine pistons 34, 36, 38, 40, combustion cylinders 42, 44, 46, 48, hot Stirling cylinders 50, 52, 54, 56, cold Stirling cylinders 58, 60, 62, 64, power unit 72, Stirling working gas passages 74, 76, barrel cam profile top 68, and barrel cam profile bottom 70, joint 78, joint 80, joint 82, joint 84, joint 100, joint 102, joint 104, joint 106, position 86, position 88, position 94, heat accumulator 94, heat accumulator 96, position 108, position 114, actuator 90, actuator 110, valve 98, and valve 112 may be of different sizes, shapes, or proportions as long as the physical constraints and relative functioning are still maintained such that the rotation of the shaft and the reciprocation of the pistons is achieved. The size, shape, and material of the particular components are largely defined by the application and therefore can deviate from the present. The power unit 72 may have any plurality of combustion cylinders, 42, 44, 46, 48, hot Stirling cylinders 50, 52, 54, 56, cold Stirling cylinders 58, 60, 62, 64, and Stirling working gas passages 66, 72.

The construction details of an embodiment of the present disclosure as shown in FIGS. 1-6 are that the power unit 72 may be made of metal, or any other sufficiently rigid and strong material, such as composites and the like. Further, the various components of the power unit 72 can be made of different material.

According to an embodiment of the present disclosure integrating a Stirling engine into a conventional engine as described above in detail, the working mode of the Stirling engine is changed to operate as the heat pump when required to do negative work in order to transform the kinetic energy of the powertrain into the temperature differential energy and to accumulate it. Furthermore, the power unit's ability to utilize waste heat from the internal heat engine offers a way of increasing the efficiency of an engine or powertrain.

The above embodiments have dealt with the power unit with an integrated Stirling engine and internal heat engine within a vehicle. However, the power unit described herein may be applied to various types of engines, powertrains, applications, etc. The disclosure may be applied to power generation, power recovery, heat recovery, and should not be limited by the above example embodiments and their descriptions.

Although the above examples and figures have disclosed a power unit equipped with 4 hot Stirling pistons and 4 cold Stirling pistons positioned axially around a rotating shaft fixed to a barrel cam in addition to 4 internal combustion chambers and corresponding pistons, the invention can be applied in different configurations.

Alternate embodiments of the present invention may include the use of any number of Stirling engine pistons and chambers. In an alternate embodiment there could be 4 Stirling engine pistons in which 2 pistons would be located on the hot Stirling engine side and 2 pistons located on the cold Stirling engine side.

Similarly, an alternate embodiment may include the use of any number of combustion pistons and corresponding combustion cylinders. Depending upon the application, a configuration with 2 combustion pistons and cylinders may be used. Similarly, a configuration with 5 or 6 combustion pistons and cylinders may be used.

Furthermore, the power unit may utilize a number of combustion cycles and is not limited to a four-stroke engine cycle. For example, the power unit may use a two stroke engine cycle or a six stroke engine cycle, e.g., the six stroke engine cycle consisting of the following strokes: intake, compression, ignition, exhaust compression, steam power stroke, and a final exhaust stroke.

The size and shape of the various components such as the pistons, barrel cams, cylinders, Stirling passages may also be altered. The total displacement of the internal combustion can be altered by changing the bore, stroke, and length of the combustion chamber. The compression ratio of the engine may also be altered by changing the bore, stroke, and length of the combustion chamber.

Additionally, multiple power units may be coupled together. To accomplish this, the power units may utilize an axial coupling or clutch-like mechanism that would physically constrain the power units output shaft to one another and align the shafts' centerlines to be both parallel and co-linear. Furthermore, two power units may be constrained together through the use of a gear train. In this configuration, two parallel but non-collinear shafts would be physically constrained together by meshing gears. The gear train may contain any number of gears to not only physically constrain the rotation of each power units shaft but to ensure the proper direction of rotation and accommodate any additional accessories such as a power Stirling pump, alternator, or similar device.

What is claimed is:

1. An apparatus, comprising:
a barrel cam defining first and second planes and a substantially cylindrical body between the first and second planes and normal to the planes;
a plurality of combustion pistons coupled to the barrel cam and longitudinally disposed relative to the barrel cam so that the combustion pistons longitudinally traverse through the first plane during actuation;
a plurality of first Stirling pistons coupled to the barrel cam and longitudinally disposed relative to the barrel cam so that the first Stirling pistons longitudinally traverse through the first plane during actuation;
a plurality of second Stirling pistons coupled to the barrel cam and longitudinally disposed relative to the barrel cam so that the second Stirling pistons longitudinally traverse through the second plane during actuation; and
wherein at least one of the combustion pistons and at least one of the first or second Stirling pistons are coupled to the barrel cam so that the barrel cam rotates during actuation of the at least one of the combustion pistons and the at least one of the first or second Stirling pistons.

2. The apparatus of claim 1, wherein the barrel cam comprises a first profile and a second profile, the combustion pistons and the first Stirling pistons are coupled to the first profile, and the second Stirling pistons are coupled to the second profile.

3. The apparatus of claim 1, wherein each piston is coupled to a corresponding profile of the barrel cam by a follower.

4. The apparatus of claim 1, further comprising:
a housing enclosing the barrel cam and pistons, the housing comprising:
a first section including, for each of the combustion pistons and first Stirling pistons, a chamber for receiving the piston; and
a second section including, for each of the second Stirling pistons, a chamber for receiving the piston; and
an output shaft coupled to the barrel cam, the output shaft being longitudinally disposed relative to the barrel cam, wherein a first end of the output shaft protrudes from the first section of the housing, and a second end of the output shaft protrudes from the second section of the housing.

5. The apparatus of claim 4, further comprising:
a plurality of fluid passages that each connect a chamber for one of the first Stirling pistons to a corresponding chamber for one of the second Stirling pistons; and
a phase changing device coupled to two or more of the fluid passages, the phase changing device being operable to switch the chambers to which the two or more fluid passages correspond.

6. The apparatus of claim 4, wherein each corresponding profile is defined sinusoidally by the barrel cam.

7. The apparatus of claim 6, wherein each sinusoidal profile is defined by the barrel cam such that a first phase for one of the first Stirling pistons is ninety degrees relative to a corresponding one of the second Stirling pistons.

8. The apparatus of claim 6, wherein each sinusoidal profile is defined by the barrel cam such that a first phase for one of the first Stirling pistons is negative ninety degrees relative to a corresponding one of the second Stirling pistons.

9. The apparatus of claim 1, wherein a first section of the barrel cam coupled to the combustion pistons and first Stirling pistons has a radius that is different from a second section of the barrel cam that is coupled to the second Stirling pistons.

10. A power unit, comprising:
an internal heat engine;
an integrated Stirling engine;
a heating portion for heating an operation fluid;
a cooling portion for cooling an operation fluid; and
a Stirling phase changing device, wherein the heating portion and the cooling portion having a plurality of heat accumulators arranged therein, and wherein the Stirling phase changing device is operable to change the integrated Stirling engine to a heat pump operation.

11. The power unit of claim 10, further comprising a plurality of Stirling passages, a plurality of heat accumulators, and a plurality of regenerators which are integrated into an engine block.

12. The power unit of claim 10, further comprising:
a multi-profiled barrel cam defining a plurality of profiles that position a plurality of combustion pistons, a plurality of hot Stirling pistons, and a plurality of cold Stirling pistons.

13. The power unit of claim 10, wherein a plurality of pistons are transitionally constrained to a multi-profiled barrel cam by a follower.

14. The power unit of claim 13, wherein each piston comprises one solid piece of material that comprises both a connecting rod and a piston.

15. The power unit of claim 12, wherein the profiles defined by the multi-profiled barrel cam are approximately 90 degrees out of phase.

16. The power unit of claim 10, wherein the Stirling phase changing device comprises a directional valve that modifies a plurality of Stirling working fluid passages.

17. A power unit comprising an integrated Stirling engine and a directional valve device that modifies a Stirling working fluid passages in order to achieve a relative phase change between a heating portion and a cooling portion of the integrated Stirling engine.

18. A power unit comprising an internal heat engine and an integrated Stirling engine constrained by a multi-profiled barrel cam such that the internal heat engine and integrated Stirling engine are physically constrained to each other such that the movement of one causes the movement of the other.
